(19) United States
(12) Patent Application Publication
(10) Pub. No.: US 2015/0039823 A1
(43) Pub. Date: Feb. 5, 2015

(54) TABLE LOOKUP APPARATUS USING CONTENT-ADDRESSABLE MEMORY BASED DEVICE AND RELATED TABLE LOOKUP METHOD THEREOF

(71) Applicant: MEDIATEK INC., Hsin-Chu (TW)

(72) Inventor: Hong-Ching Chen, Kao-Hsiung City (TW)

(73) Assignee: MEDIATEK INC., Hsin-Chu (TW)

(21) Appl. No.: 14/280,698

(22) Filed: May 19, 2014

Related U.S. Application Data
(60) Provisional application No. 61/859,796, filed on Jul. 30, 2013.

(51) Int. Cl. G06F 17/30

(52) U.S. Cl. CPC G06F 17/30982
USPC 711/108

(57) ABSTRACT

A table lookup apparatus has a content-addressable memory (CAM) based device and a first cache. The CAM based device is used to store at least one table. The first cache is coupled to the CAM based device, and used to cache at least one input search key of the CAM based device and at least one corresponding search result. Besides, the table lookup apparatus may further includes a plurality of second caches and an arbiter. Each second cache is used to cache at least one input search key of the CAM based device and at least one corresponding search result. The arbiter is coupled between the first cache and each of the second caches, and used to arbitrate access of the first cache between the second caches.

### CROSS REFERENCE TO RELATED APPLICATIONS

This application claims the benefit of U.S. provisional application No. 61/859,796, filed on Jul. 30, 2013 and incorporated herein by reference.

### BACKGROUND

The disclosed embodiments of the present invention relate to performing data comparison, and more particularly, to a table lookup apparatus using a content-addressable memory (CAM) based device and related table lookup method thereof.

Content-addressable memory (CAM) is a type of memory especially suitable for high speed applications. More specifically, a CAM is a memory device that accelerates any application requiring a fast search of a database. The CAM compares an input search key against a stored table composed of data words, and returns the address of the matching data word in the table. In other words, in the CAM, stored data words within a CAM array is not accessed by initially supplying an address, but rather by initially applying the input search key to the CAM array and then performing a compare operation to identify one or more row locations within the CAM array that contain data equivalent to the applied input search data and thereby represent a “match” or “hit” condition. In this manner, stored data is accessed according to its content rather than its address. Hence, the CAM device is a good choice for implementing a lookup operation due to its fast search capability. However, a common problem that many manufacturers of CAMs encounter is that their CAMs consume too much power in performing search operations and do not have optimal search speeds.

### SUMMARY

In accordance with exemplary embodiments of the present invention, a table lookup apparatus using a content-addressable memory (CAM) based device and related table lookup method thereof are proposed to solve the above-mentioned problem.

According to a first aspect of the present invention, an exemplary table lookup apparatus is disclosed. The exemplary table lookup apparatus includes a content-addressable memory (CAM) based device and a first cache. The CAM based device is configured to store at least one table. The first cache is coupled to the CAM based device, and configured to cache at least one input search key of the CAM based device and at least one corresponding search result.

According to a second aspect of the present invention, an exemplary table lookup apparatus is disclosed. The exemplary table lookup apparatus includes a content-addressable memory (CAM) based device and a scope mask circuit. The CAM based device has CAM entries configured to vertically store a plurality of tables in a word-wise aggression fashion, wherein the CAM entries are responsive to a valid bit input including valid bits of the CAM entries, and a CAM entry is valid when receiving a corresponding valid bit set by a first logic value and is invalid when receiving the corresponding valid bit set by a second logic value. The scope mask circuit is configured to mask a portion of the valid bit input by assigning the second logic value to each valid bit included in the portion of the valid bit input, wherein the portion of the valid bit input corresponds to non-selected table(s).

According to a third aspect of the present invention, an exemplary table lookup apparatus is disclosed. The exemplary table lookup apparatus includes a content-addressable memory (CAM) based device and a control logic. The CAM based device has a plurality of main CAM entries and at least a redundant CAM entry. The control logic is configured to program the redundant CAM entry by a data word to serve as a new main CAM entry, utilize the new main CAM entry as replacement of a specific main CAM entry in the CAM based device, and program the specific main CAM entry by the data word.

According to a fourth aspect of the present invention, an exemplary table lookup method is disclosed. The exemplary table lookup method includes: storing at least one table in a content-addressable memory (CAM) based device; and caching at least one input search key of the CAM based device and at least one corresponding search result.

According to a fifth aspect of the present invention, an exemplary table lookup method is disclosed. The exemplary table lookup method includes: vertically storing a plurality of tables in content-addressable memory (CAM) entries of a CAM based device in a word-wise aggression fashion, wherein the CAM entries are responsive to a valid bit input including valid bits of the CAM entries, and a CAM entry is invalid when receiving a corresponding valid bit set by a predetermined logic value; and masking a portion of the valid bit input by assigning the predetermined logic value to each valid bit included in the portion of the valid bit input, wherein the portion of the valid bit input corresponds to non-selected table(s).

According to a sixth aspect of the present invention, an exemplary table lookup method is disclosed. The exemplary table lookup method includes: utilizing a content-addressable memory (CAM) based device having a plurality of main CAM entries and at least a redundant CAM entry; programming the redundant CAM entry by a data word to serve as a new main CAM entry; utilizing the new main CAM entry as replacement of a specific main CAM entry in the CAM based device; and programming the specific main CAM entry by the data word.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a table lookup apparatus according to a first embodiment of the present invention.

FIG. 2 is a diagram illustrating a cache coherence mechanism employed by a table lookup apparatus according to an embodiment of the present invention.

FIG. 3 is a diagram illustrating a table lookup apparatus according to a second embodiment of the present invention.

FIG. 4 is a diagram illustrating queuing latency reduction resulting from applying level-two caches to a TCAM according to an embodiment of the present invention.

FIG. 5 is a diagram illustrating the “Hit on Miss” operation performed by a non-blocking cache according to an embodiment of the present invention.

FIG. 6 is a diagram illustrating the out-of-order transaction of a cache according to an embodiment of the present invention.

FIG. 7 is a diagram illustrating a table lookup apparatus according to a third embodiment of the present invention.

FIG. 8 is a diagram illustrating a table lookup apparatus according to a fourth embodiment of the present invention.

FIG. 9 is a diagram illustrating a TCAM unit macro according to an embodiment of the present invention.

FIG. 10 is a diagram illustrating a table lookup apparatus according to a fifth embodiment of the present invention.

FIG. 11 is a diagram illustrating a CAM based device with a programmable priority order of CAM entries.

FIG. 12 is a diagram illustrating a CAM based device supporting simultaneous lookup operations for different tables according to an embodiment of the present invention.

FIG. 13 is a diagram illustrating a table lookup apparatus according to a sixth embodiment of the present invention.

FIG. 14 is a diagram illustrating a table update task performed by the table lookup apparatus shown in FIG. 13.

FIG. 15 is a diagram illustrating a runtime test performed by the table lookup apparatus shown in FIG. 13.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

One key idea of the present invention is to provide an innovative table lookup design for network applications by using a CAM based device (e.g., a TCAM (Ternary Content-Addressable Memory)) collaborating with a cache system (e.g., a single-level or multi-level cache system) to achieve lower power consumption as well as higher search speed. Besides, a single CAM based device may be shared by multiple tables through table aggregation, thereby achieving more flexibility. Further, the CAM based device may be equipped with at least one redundant CAM entry (e.g., at least one repair slot), such that the redundant CAM entry may be used for avoiding the search stall caused by table update or runtime test. Further details of the present invention are described as below.

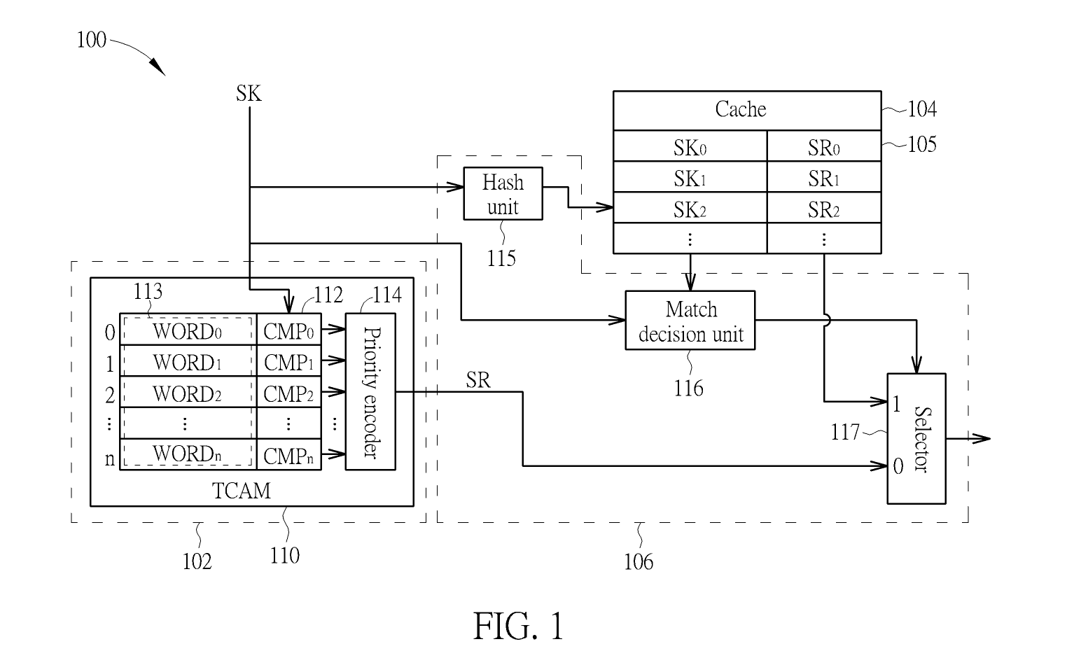

FIG. 1 is a diagram illustrating a table lookup apparatus according to a first embodiment of the present invention. In this embodiment, the table lookup apparatus 100 includes a content-addressable memory (CAM) based device 102, a cache 104 and a cache controller 106. For example, the CAM based device 102 may be implemented using a TCAM 110 with a plurality of TCAM entries (also known as TCAM rows or TCAM words) 112 and a priority encoder 114, where each TCAM entry stores a data word (e.g., WORD₀-WORDₙ) and has a comparator (e.g., CMP₀-CMPₙ). When an input search key SK is received by the TCAM 110, the input search key SK is compared with each data word by the corresponding comparator. The data word in each TCAM entry is a string of bits stored in TCAM cells (not shown), where each bit is either ‘0’, ‘1’ or ‘X (don't care)’. For example, a stored data word of “100X” would match the input search key of “1000” or “1001”. Hence, it is possible that there are multiple matching TCAM entries for one input search key. The priority encoder 114 is therefore used to select the first matching TCAM entry, i.e., a matching TCAM entry with higher priority among all matching TCAM entries, and use an entry index of the selected TCAM entry to set a search result SR for the input search key SK. It should be noted that TCAM 110 is merely an example of the CAM based device 102, and is not meant to be a limitation of the present invention. In an alternative design, the CAM based device 102 may be implemented using a CAM composed of CAM cells each being either “1” or “0”. This also belongs to the scope of the present invention. In the following, the term “TCAM” and “CAM” may be interchangeable.

When the TCAM 110 is used in a network application, the input search key SK may be a packet header of an incoming packet, and the data words WORD₀-WORDₙ stored in a TUM (TCAM unit macro) composed of TCAM entries may be a table 113 established by a set of predetermined rules, where each predetermined rule is one data word stored in one TCAM entry. Hence, the TCAM 110 compares the packet header with the set of predetermined rules to find which rule matches the packet header. The search result SR indicates the location of the first matching TCAM entry, and serves as a rule index transmitted to a following rule action table (not shown) for selecting a rule action from a plurality of predetermined rule actions, such as “permit”, “deny”, replication, QoS (Quality of Service) control, etc. A packet processing engine (not shown) will process the incoming packet based on the selected rule action. When a source device tries to establish a link with a destination device through the network, a burst of packets (also known as a packet train) coming from the same source device and heading to the same destination device may occur. Since the network addresses of the source device and the destination device are fixed, packet headers of successive packets belonging to the same packet train may be similar. Hence, the same rule defined in the table 113 may match several packet headers in a row. In other words, the ingress packets for the same traffic flow are with the similar/same packet header, which means the recently accessed TCAM data word is possibly to be accessed again in a short time. Based on the temporal locality of the TCAM table lookup, the present invention therefore proposes using the cache architecture to boost the TCAM bandwidth and reduce the TCAM operation power.

The cache controller 106 is used to control access of the cache 104, and includes a hash unit 115, a match decision unit 116 and a selector 117. The cache 104 is coupled to the TCAM 110 through the cache controller 106, and configured to cache at least one input search key of the TCAM 110 and at least one corresponding search result. For example, when the input search key is SK₀ and a cache miss occurs, the input search key SK₀ is input to the TCAM 110 for data comparison, and a corresponding search result SR₀ is obtained. The input search key SK₀ and the corresponding search result SR₀ may be cached in the cache 104 by an employed replacement policy. Similarly, when the input search key is SK₁/SK₂ and a cache miss occurs, the input search key SK₁/SK₂ is input to the TCAM 110 for data comparison, and a corresponding search result SR₁/SR₂ is obtained. The input search key SK₁/SK₂ and the corresponding search result SR₁/SR₂ may be cached in the cache 104 by the employed replacement policy.

The number of cache lines 105 in the cache 104 is smaller than the number of TCAM entries 112 in the TCAM 110. Hence, the hash unit 115 generates a hash value for the input search key SK, and outputs the hash value as a cache line index. The match decision unit 116 compares the input search key SK with a cached search key (e.g., SK₂) retrieved from a cache line pointed to by the hash value generated from the hash unit 115. When the input search key SK matches the cached search key, a cache hit occurs. The match decision unit 116 controls the selector 117 to directly output a cached search result (e.g., SR₂) retrieved from the cache line pointed to by the hash value generated from the hash unit 115 as a search result of the input search key SK. In this way, no data comparison for the input search key SK is performed inside the TCAM 110, which leads to reduction of the power consumption.

When the input search key SK does not match the cached search key, a cache miss occurs. The TCAM 110 is required to perform data comparison for the input search key SK, and accordingly generates the search result SR. The match decision unit 116 controls the selector 117 to output the search result SR retrieved from the TCAM 110. Besides, the search key SK₂ and search result SR2 cached in the cache line pointed to by the hash value generated from the hash unit 115 may be selectively replaced with the input search key SK and the search result SR, depending upon the employed replacement policy.

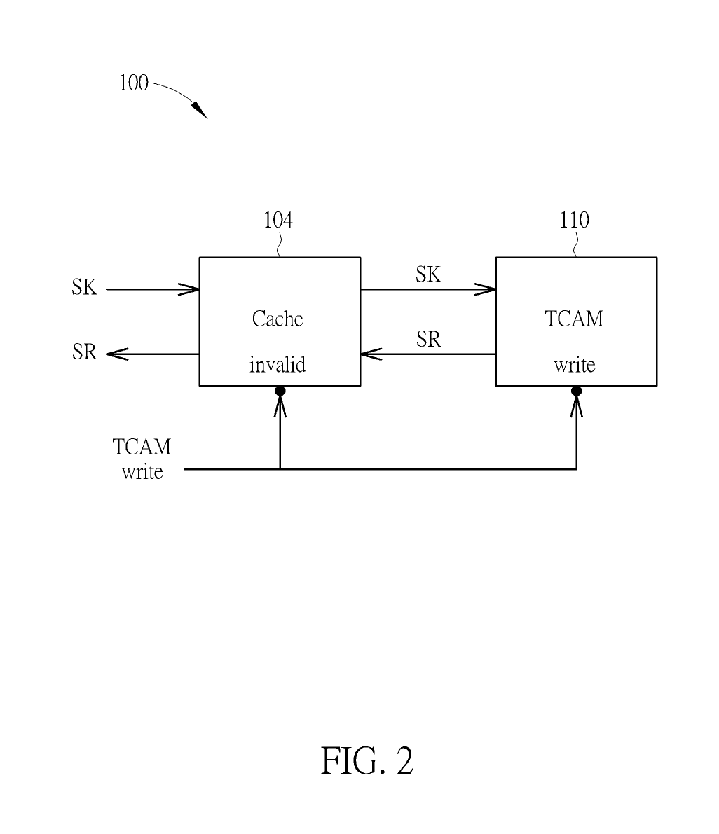

As mentioned above, at least one search key and at least on corresponding search result associated with the table 113 in the TCAM 110 are cached in the cache 104. Hence, one cached search result may be reused if one cached search key is found identical to the input search key. It is possible that at least one entry is inserted into the table 113, at least one entry is removed from the table 113, and/or at least one entry of the table 113 is modified. Hence, a cache coherence mechanism is also employed by the proposed table lookup apparatus 100, as shown in FIG. 2. The cache 104 invalidates/clears its cached data each time a table content in the TCAM 110 is changed.

A comparison between several inherent characteristics of cache 104 and TCAM 110 is illustrated by the following table.

| | Cache | TCAM |
|---|---|---|
| Max speed | 1~1.5 GHz | 800 MHz~1 GHz |
| Latency | 1 T | 3 T+ |
| Power consumption | Small | Huge |

As can be known from above table, the cache 104 has faster access speed, lower latency, and lower power consumption. Since the single-level cache architecture is employed, the cache 104 is able to reduce power consumption and latency of the TCAM lookup, and boost the TCAM bandwidth by a high cache hit rate. In short, using the cache is able to avoid the bottleneck of the TCAM and reduce the power consumption of the TCAM. In an alternative design, the multi-level cache architecture may be employed to offer more benefits/advantages, compared to the single-level cache architecture.

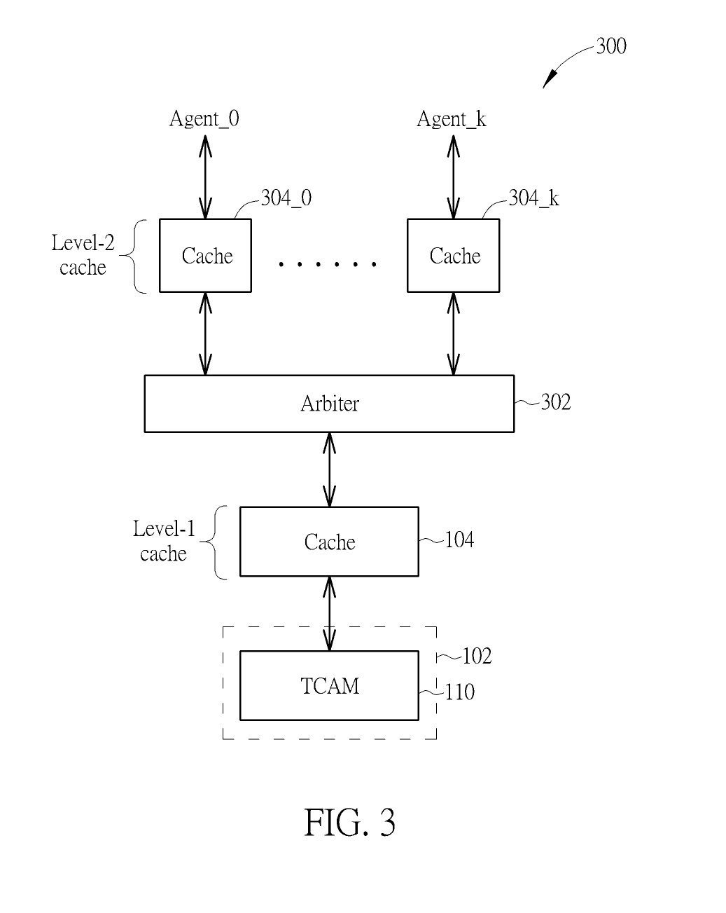

Please refer to FIG. 3, which is a diagram illustrating a table lookup apparatus according to a second embodiment of the present invention. In this embodiment, the table lookup apparatus 300 employs the two-level cache architecture. Hence, besides the aforementioned CAM based device 102 (which may be implemented using TCAM 110) and cache 104 (which serves as a level-one cache), the table lookup apparatus 300 includes an arbiter 302 and a plurality of caches 304_0-304_{—}k (which serve as level-two caches). The caches 304_0-304_{—}k may receive input search keys from different agents Agent_0-Agent_k, respectively. The function of each level-two cache is similar to that of the level-one cache, and the major difference therebetween is that the level-two cache asks the level-one cache for a search result of an input search key when a cache miss occurs. As a single level-one cache (i.e., cache 104) is shared between multiple level-two caches (i.e., caches 304_0-304_{—}k), the arbiter 302 coupled between cache 104 and each of caches 304_0-304_{—}k is configured to arbitrate access of one level-one cache 104 between multiple level-two caches 304_0-304_{—}k.

Using the caches 304_0-304_{—}k is able to further reduce the bandwidth requirement of TCAM. Suppose that the bandwidth of agents is 2.5 G pps (packet per second). As shown in above table, the TCAM only has the access speed of 800 MHz˜1 GHz, and is unable to have enough bandwidth for directly serving input search keys (e.g., packet headers) from the agent. With the help of the multi-level cache architecture, the bandwidth requirement of TCAM can be relaxed. For example, in a case where the miss rate of the level-two cache is 50%, and the miss rate of the level-one cache is 30%. The bandwidth requirement of TCAM may be expressed using following equation.

TCAM BW requirement=2.5 G pps×50%×30%=375 M pps (1)

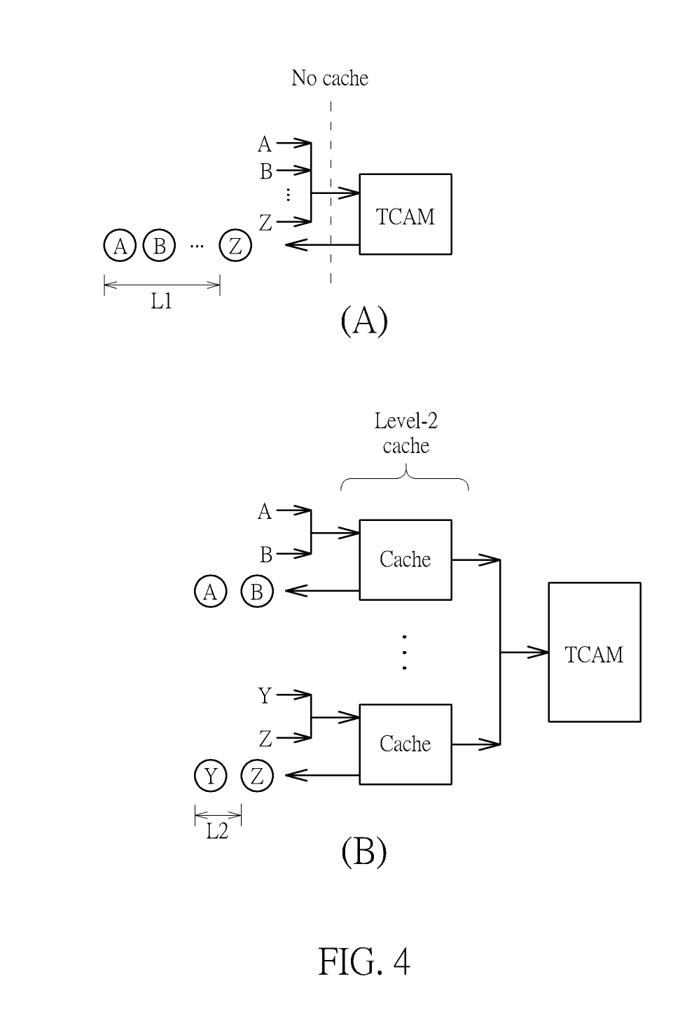

Further, using the caches 304_0-304_{—}k is able to reduce the queuing latency. Please refer to FIG. 4, which is a diagram illustrating queuing latency reduction resulting from applying level-two caches to a TCAM according to an embodiment of the present invention. As shown in sub-diagram (A) of FIG. 4, when no cache is applied to the TCAM, multiple input search keys A-Z should be queued and then sequentially fed into the TCAM for data comparison. As a result, the search results are sequentially generated from the TCAM, wherein the search results are represented by the symbols “\textcircled{A}” . . . “\textcircled{Z}” as shown in FIG. 4. The search result \textcircled{Z} is obtained after all of the search results \textcircled{A}˜\textcircled{Y} are obtained. There is latency L1 between the first search result \textcircled{A} and the last search result \textcircled{Z}.

As shown in sub-diagram (B) of FIG. 4, multiple level-two caches are used, and each level-two cache serves two of the input search keys A-Z. Hence, only two input search keys A and B are queued and then sequentially fed into the first level-two cache, and only two input search keys Y and Z are queued and then sequentially fed into the last level-two cache. Supposing that each of the first level-two cache and the last level-two cache has cache hits for successive input search keys, the search results \textcircled{A}˜\textcircled{B} are sequentially generated from the first level-two cache, and the search results \textcircled{Y}˜\textcircled{Z} are sequentially generated from the last level-two cache. Due to the parallel processing of the input search keys, the search results \textcircled{A} and \textcircled{Y} may be obtained at the same time, and the search results \textcircled{B} and \textcircled{Z} may be obtained at the same time. Hence, there is latency L2 between the search results \textcircled{A} and \textcircled{Z}, where L2<L1. To put it simply, the major latency of TCAM lookup is from search key queuing, rather than the latency of TCAM. The level-two caches are helpful to eliminate the latency resulting from search key queuing.

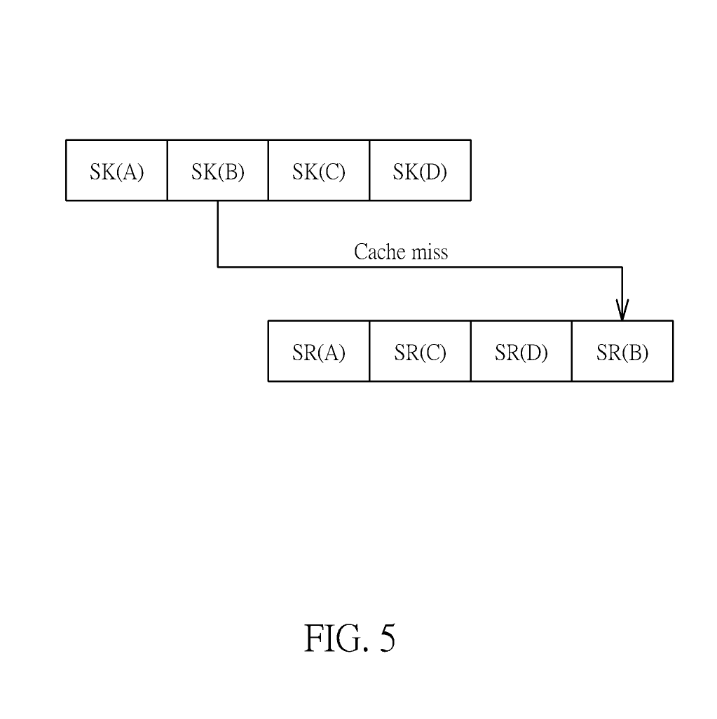

In general, the packets from different traffic flows do not have the dependency to each other. In an exemplary design, the process of packets may be reordered to improve the performance of the TCAM lookup. To fully utilize the property of packet reordering, caches 104 and 304_0-304_{—}k may be non-blocking caches to support “Hit on Miss” that can process independent cache accesses concurrently with waiting of cache misses. Please refer to FIG. 5, which is a diagram illustrating the “Hit on Miss” operation performed by a non-blocking cache according to an embodiment of the present invention. For example, the cache 104 is a non-blocking cache, and receives input search keys SK (A), SK(B), SK(C), SK(D) one by one. The cache 104 has a cache hit for the input search key SK (A), and outputs the cached search result SR(A). The cache 104 has a cache miss for the input search key SK(B). Hence, the cache 104 may request the TCAM 110 for the search result SR(B) and start processing the next input search key SK(C), concurrently. As shown in FIG. 5, the cache 104 has a cache hit for each of the following input search keys SK(C) AND SK(D), and sequentially outputs the cached search results SR(C) and SR(D). Next, the search result SR(B) fetched from the TCAM 110 is outputted. The advantage of the non-blocking cache is to hide the miss penalty of the cache behind the ongoing cache access transaction.

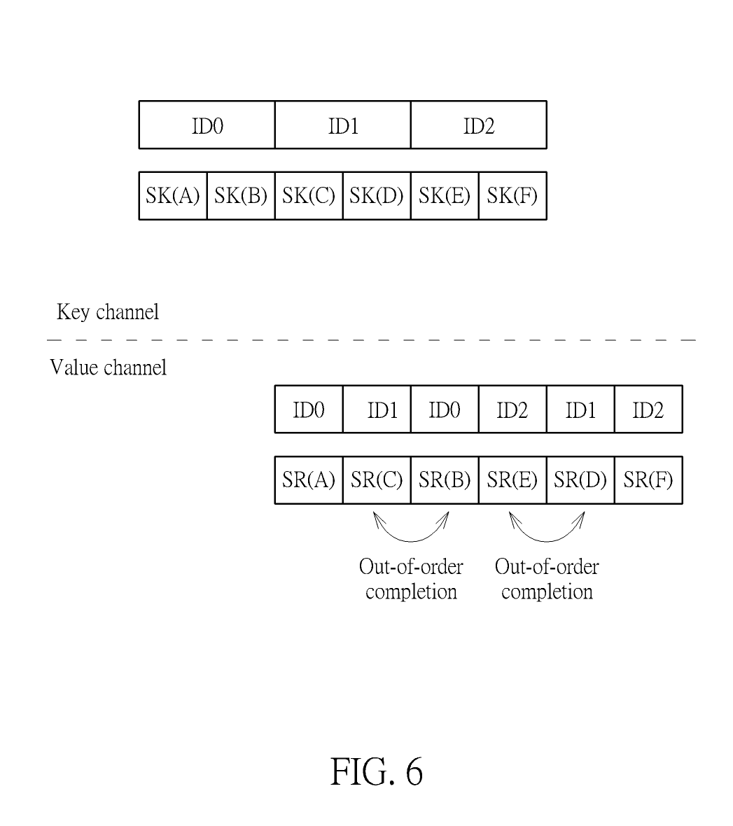

In an exemplary design, the interface protocol may support the out-of-order transaction. Therefore, the caches 104 and 304_0-304_{—}k may be configured to support the out-of-order completion. Please refer to FIG. 6, which is a diagram illustrating the out-of-order transaction of a cache according to an embodiment of the present invention. For example, the cache 104 supports the out-of-order completion, and the key channel for transmitting input search keys and the value channel for transmitting search results are separated. The channel identifier (ID) is used to provide the dependency information of transaction. For example, the channel ID may be a serial number of an ingress port, a hash value of a MAC (Media Access Control) address, a hash value of an IP (Internet Protocol) address, etc. Concerning the example shown in FIG. 6, the input search keys SK(A) and SK(B) have the same channel ID ID0, the input search keys SK(C) and SK(D) have the same channel ID ID1, and the input search keys SK(E) and SK(F) have the same channel ID ID2. The cache 104 can reorder the processing of input search keys SK(A)-SK(F), where the processing order of input search keys having the same channel ID is not changed, and the processing order of input search keys having different channel IDs is allowed to be adjusted. As shown in FIG. 6, the processing order of input search key SK(B) and SK(C) have different channel IDs are reordered, such that the search result SR(B) is obtained after the search result SR(C) is obtained; and the processing order of input search key SK(D) and SK(E) have different channel IDs are reordered, such that the search result SR(D) is obtained after the search result SR(E) is obtained. However, the input search key SK(A) and SK(B) have the same channel ID ID0 are still processed by the cache 104 in a sequential order, such that the search result SR(B) is obtained after the search result SR(A) is obtained; the input search keys SK(C) and SK(D) have the same channel ID ID1 are still processed by the cache 104 in a sequential order, such that the search result SR(D) is obtained after the search result SR(C) is obtained; and input search keys SK(E) and SK(F) have the same channel ID ID2 are still processed by the cache 104 in a sequential order, such that the search result SR(F) is obtained after the search result SR(E) is obtained.

In an exemplary design, the same CAM based device 102 may have multiple tables allocated therein to obtain more table lookup flexibility. According to the present invention, there are two types of table aggregation to share a single CAM based device (e.g., TCAM) with several tables. One is bit-wise aggregation, and the other is word-wise aggregation.

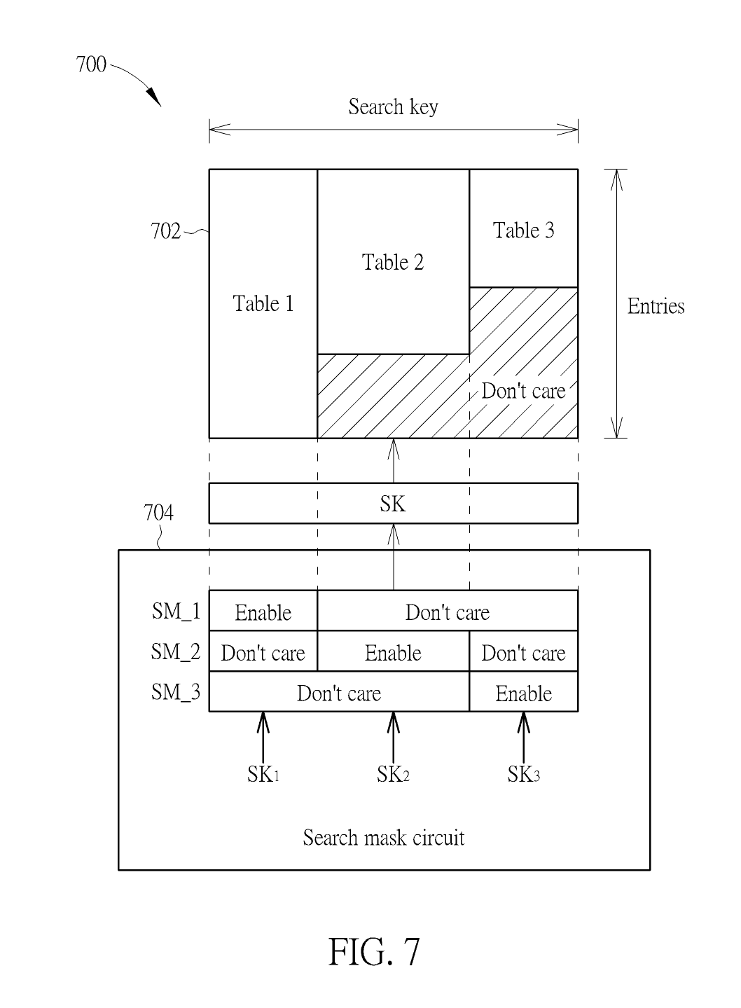

Please refer to FIG. 7, which is a diagram illustrating a table lookup apparatus according to a third embodiment of the present invention. In this embodiment, the bit-wise aggregation for allocating multiple tables in a single CAM based device is employed by the table lookup apparatus 700. The table lookup apparatus 700 includes a CAM based device such as a TCAM 702, and further includes a search mask circuit 704. The TCAM 702 is used to horizontally store a plurality of tables in a bit-wise aggression fashion. As shown in FIG. 7, these tables have different sizes. Hence, one data word stored in the same TCAM entry may include a first portion belonging to a first table, a second portion belonging to a second table, and a third portion belonging to a third table; another data word stored in the same TCAM entry may include a first portion belonging to a first table, a second portion belonging to a second table, and a third portion belonging to TCAM cells each having a “don't care” state; and yet another data word stored in the same TCAM entry may include a first portion belonging to a first table and a second portion belonging to TCAM cells each having a “don't care” state.

The search mask circuit 704 is configured to mask a portion of an input search key SK of the CAM based device (e.g., TCAM 702), wherein the portion of the input search key SK corresponds to non-selected table(s), and a remaining portion of the input search key SK corresponds to a selected table. In this embodiment, since there are three tables, the search mask circuit 704 is configured to have three search masks SM_{—}1, SM_{—}2, SM_{—}3, and enable one of the search masks SM_{—}1, SM_{—}2, SM_{—}3 based on which of the tables is selected for data comparison. For example, when the first table (denoted as “Table 1”) is selected for data comparison, the search mask SM_{—}1 is used such that the head part of the input search key SK is set by a search key SK₁ for the first table, and each bit position in the middle part and the tail part is set by a don't care bit. In this way, the search key SK₁ is compared with all entries in the first table in parallel, and a corresponding search result is generated without interference of the second table and the third table due to don't’ care bits intentionally set in the input search key SK by the search mask circuit 704.

When the second table (denoted as “Table 2”) is selected for data comparison, the search mask SM_{—}2 is used such that the middle part of the input search key SK is set by a search key SK₂ for the second table, and each bit position in the head part and the tail part is set by a don't care bit. In this way, the search key SK₂ is compared with all entries in the second table in parallel, and a corresponding search result is generated without interference of the first table and the third table due to don't’ care bits intentionally set in the input search key SK by the search mask circuit 704.

When the third table (denoted as “Table 3”) is selected for data comparison, the search mask SM_{—}3 is used such that the tail part of the input search key SK is set by a search key SK₃ for the third table, and each bit position in the head part and the middle part is set by a don't care bit. In this way, the search key SK₃ is compared with all entries in the third table in parallel, and a corresponding search result is generated without interference of the first table and the second table due to don't’ care bits intentionally set in the input search key SK by the search mask circuit 704.

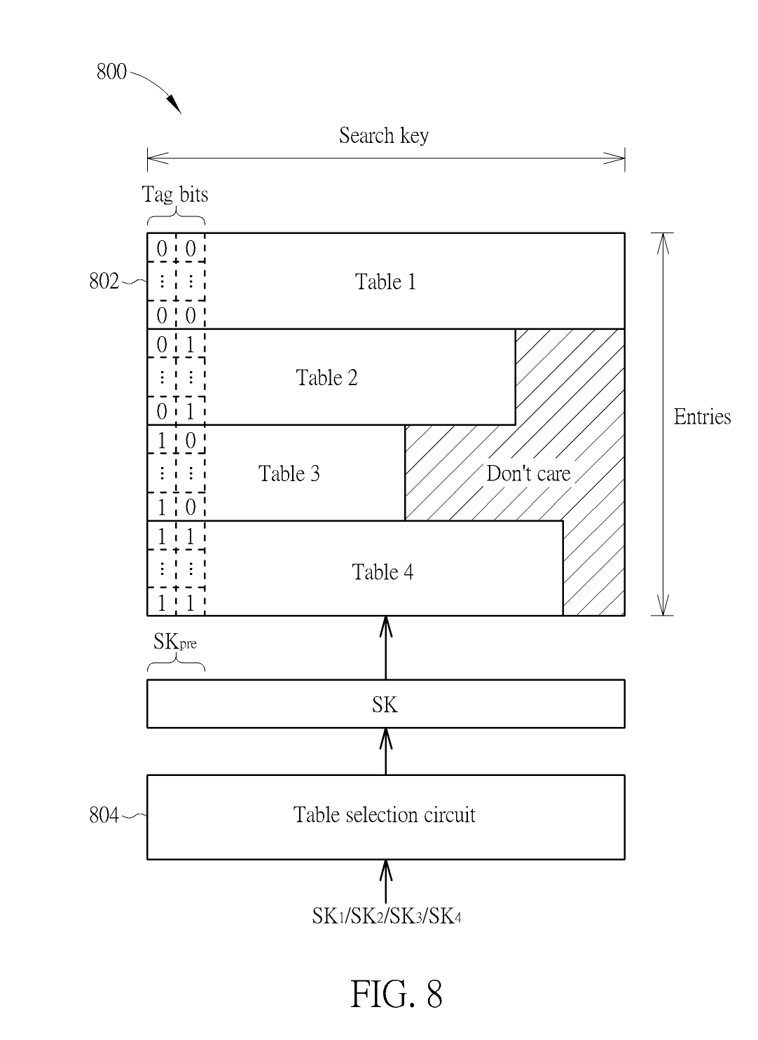

Please refer to FIG. 8, which is a diagram illustrating a table lookup apparatus according to a fourth embodiment of the present invention. In this embodiment, the word-wise aggregation for allocating multiple tables in a single CAM based device is employed by the table lookup apparatus 800. The table lookup apparatus 800 includes a CAM based device such as a TCAM 802, and further includes a table selection circuit 804. The TCAM 802 is used to vertically store a plurality of tables in a word-wise aggression fashion. As shown in FIG. 8, the tables have different sizes. Hence, one TCAM column may include a first portion belonging to a first table, a second portion belonging to a second table, a third portion belonging to a third table, and a fourth portion belonging to a fourth table; another TCAM column may include a first portion belonging to a first table, a second portion belonging to a second table, and a third portion belonging to TCAM cells each having a “don't care” state, and a fourth portion belonging to a fourth table; yet another TCAM column may include a first portion belonging to a first table, a second portion belonging to TCAM cells each having a “don't care” state, and a third portion belonging to a fourth table; and still yet another TCAM column may include a first portion belonging to a first table, and a second portion belonging to TCAM cells each having a “don't care” state.

Each of TCAM entries corresponding to the same table has tag bits that store the same numeric code. In contrast to using the one-hot code, using the numeric code is able to reduce the number of tag bits needed to differentiate between different tables. In this example, the first two TCAM cells in each TCAM entry are used to store tag bits. As shown in FIG. 8, each TCAM entry of the first table (denoted as “Table 1”) stores the same numeric code “00”, each TCAM entry of the second table (denoted as “Table 2”) stores the same numeric code “01”, each TCAM entry of the third table (denoted as “Table 3”) stores the same numeric code “10”, and each TCAM entry of the fourth table (denoted as “Table 4”) stores the same numeric code “11”.

Since each table is mapped to a unique numeric code, the tag bits set by different numeric codes are used to differentiate between different tables. The table selection circuit 804 is configured to set a numeric code of a selected table in an input search key SK of the CAM based device (e.g., TCAM 802). More specifically, the input search key SK includes a prefix key SKpre set by a numeric code of a selected table. For example, when the first table is selected for data comparison, the prefix key SKpre is set by the numeric code “00” and followed by a search key SK₁ for the first table. Next, the input search key SK composed of SKpre (“00”) and SK₁ is compared with all entries in the TCAM 802 in parallel. A corresponding search result of the search key SK₁ can be generated from the first table without interference of the second table, the third table and the fourth table due to the prefix key SKpre set by the numeric code “00” unique to the first table. That is, the prefix key SKpre set by numeric code “00” only allows TCAM entries in the range of the first table to have matching conditions.

Similarly, when the second table is selected for data comparison, the prefix key SKpre is set by the numeric code “01” and followed by a search key SK₂ for second table. Next, the input search key SK composed of SKpre (“01”) and SK₂ is compared with all entries in the TCAM 802 in parallel. A corresponding search result of the search key SK₂ can be generated from the second table without interference of the first table, the third table and the fourth table due to the prefix key SKpre set by the numeric code “01” unique to the second table. That is, the prefix key SKpre set by numeric code “01” only allows TCAM entries in the range of the second table to have matching conditions.

When the third table is selected for data comparison, the prefix key SKpre is set by the numeric code “10” and followed by a search key SK₃ for the third table. Next, the input search key SK composed of SKpre (“10”) and SK₃ is compared with all entries in the TCAM 802 in parallel. A corresponding search result of the search key SK₃ can be generated from the third table without interference of the first table, the second table and the fourth table due to the prefix key SKpre set by the numeric code “10” unique to the third table. That is, the prefix key SKpre set by numeric code “10” only allows TCAM entries in the range of the third table to have matching conditions.

When the fourth table is selected for data comparison, the prefix key SKpre is set by the numeric code “11” and followed by a search key SK₄ for fourth table. Next, the input search key SK composed of SKpre (“11”) and SK₄ is compared with all entries in the TCAM 802 in parallel. A corresponding search result of the search key SK₄ can be generated from the fourth table without interference of the first table, the second table and the third table due to the prefix key SKpre set by the numeric code “11” unique to the fourth table. That is, the prefix key SKpre set by numeric code “11” only allows TCAM entries in the range of the fourth table to have matching conditions.

The table lookup design shown in FIG. 8 is not power-efficient due to the fact that it has to compare all tables allocated in the same CAM based device. Besides, the number of tables allowed to be allocated in the same CAM based device is limited by how many tag bits that can be used for table selection. Moreover, the hardware cost is relatively high due to the fact that extra bits are needed to serve as tag bits for table selection. An alternative solution is proposed by the present invention to get rid of tag bits.

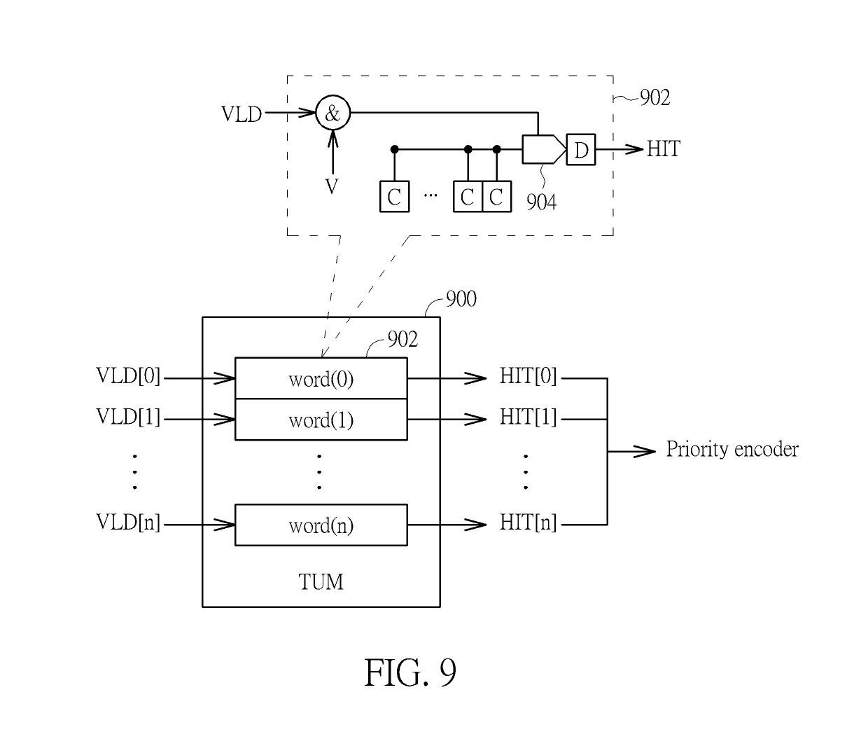

FIG. 9 is a diagram illustrating a TUM according to an embodiment of the present invention. The TUM 900 includes a plurality of TCAM entries (i.e., TCAM words) 902. Regarding each TCAM entry 902, an internal valid bit V and an external valid bit VLD may be used to indicate if the TCAM entry 902 is valid. Specifically, the pre-charge/sense circuit 904 is enabled only when both of internal valid bit V and the external valid bit VLD are set by the logic high value “1”. Hence, when the external valid bit VLD is set by the logic low value “0”, the TCAM entry 902 would be invalid due to the disabled pre-charge/sense circuit 904. The external valid bits may be properly set to save the operation power of unnecessary TCAM entries.

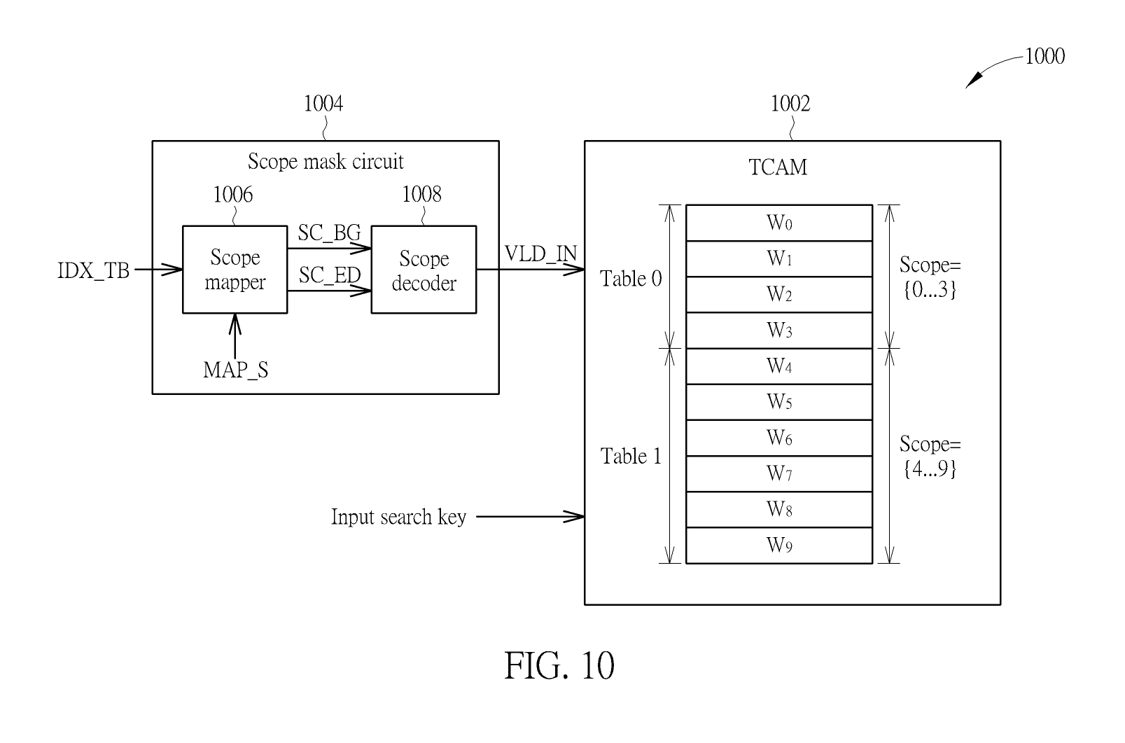

FIG. 10 is a diagram illustrating a table lookup apparatus according to a fifth embodiment of the present invention. In this embodiment, the word-wise aggregation for allocating multiple tables in a single CAM based device is employed by the table lookup apparatus 1000. The table lookup apparatus 1000 includes a CAM based device such as a TCAM 1002, and further includes a scope mask circuit 1004. The TCAM 1002 is used to vertically store a plurality of tables (e.g., Table 0 and Table 1) in a word-wise aggression fashion. The TCAM 1002 may be implemented using the TUM 900 shown in FIG. 9 to thereby have TCAM entries W₀-W₉ responsive to a valid bit input VLD_IN including external valid bits of the TCAM entries W₀-W₉. Hence, a TCAM entry is invalid when receiving a corresponding valid bit set by a predetermined logic value such as a logic low value “0”, and the TCAM entry is allowed to be valid when receiving the corresponding valid bit set by another predetermined logic value such as a logic high value “1”.

In this embodiment, the scope mask circuit 1004 is configured to mask a portion of the valid bit input VLD_IN by assigning the predetermined logic value (e.g., “0”) to each valid bit included in the portion of the valid bit input, wherein the portion of the valid bit input corresponds to non-selected table(s). Specifically, the scope mask circuit 1004 includes a scope mapper 1006 and a scope decoder 1008. The scope mapper 1006 is configured to receive a table index IDX_TB of a selected table, and generate an entry index SC_BG of a beginning TCAM entry of the selected table and an entry index SC_ED of an ending TCAM entry of the selected table. In this example, one table (i.e., Table 0) is stored in continuous CAM entries W₀-W₃, and the other table (i.e., Table 2) is stored in continuous CAM entries W₄-W₉. Hence, with regard to one of the stored tables, SC_BG=0 and SC_ED=3; and with regard to the other of the stored tables, SC_BG=4 and SC_ED=9. A scope map MAP_S may be created as below.

| Table index (IDX_TB) | Begin(SC_BG) | End(SC_ED) |
|---|---|---|
| 0(Table 0) | 0 | 3 |
| 1(Table 1) | 4 | 9 |

The scope mapper 1006 may refers to the scope map MAP_S to set the entry indices SC_BG and SC_ED in response to the received table index IDX_TB.

Next, the scope decoder 1008 is operative to set the valid bit input VLD_IN as a scope mask according to the entry index SC_BG of the beginning TCAM entry of the selected table and the entry index SC_ED of the ending TCAM entry of the selected table. For example, when SC_BG=0 and SC_ED=3, the valid bit input VLD_IN may be set by {1111000000}; and when SC_BG=4 and SC_ED=9, the valid bit input VLD_IN may be set by {0000111111}.

This solution sets an active scope to dynamically specify which TCAM entries are allowed to be compared with the input search key, and is good in both power consumption and TCAM cost.

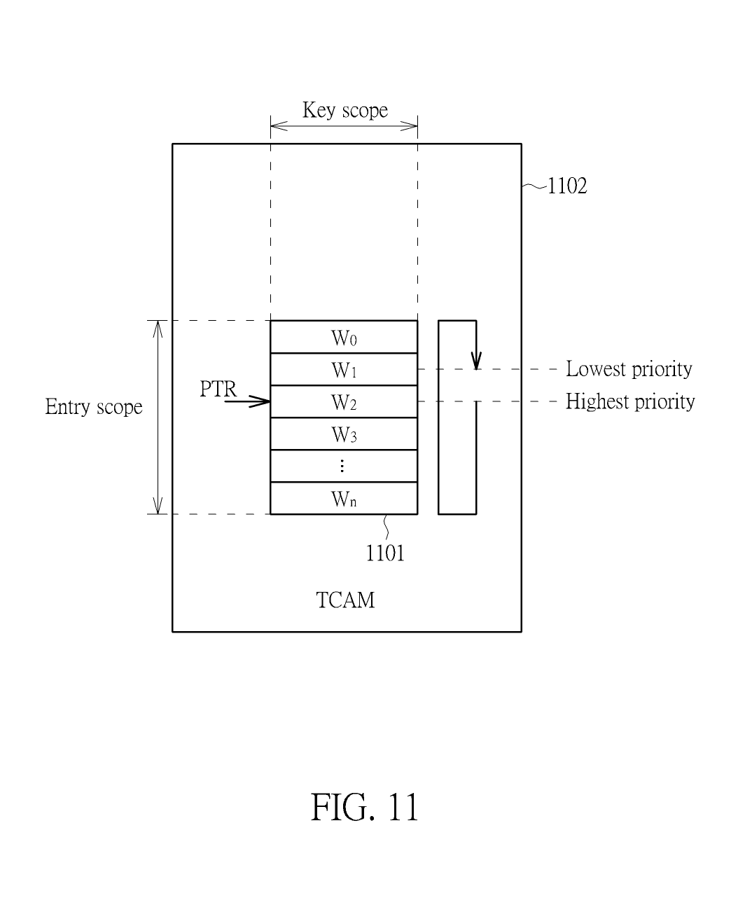

Please refer to FIG. 11, which is a diagram illustrating a CAM based device with a programmable priority order of CAM entries. A priority encoder (not shown) refers to the priority order of CAM entries to decide a search result for an input search key. One extra feature of the active scope function is to specify which CAM entry has the highest priority, and the priority order is from the specified CAM entry to the end of the active scope, and then wrapped to the start of the active scope. In this example, when the CAM entry W₂ of the selected table in a CAM based device (e.g., TCAM 1102) is pointed to by a priority pointer PTR to therefore have the highest priority. The priority order of CAM entries in the active scope corresponding to the selected table 1101 would be {W₂, W₃ . . . Wₙ, W₀, W₁}. The priory order of CAM entries may be adjusted by programming the priority pointer PTR. Moreover, as shown in FIG. 11, another extra feature of the active scope function is that the active scope function may collaborate with the search mask function used in the example shown in FIG. 7 to select any table allocated in the TCAM 1102, where the search mask function specifies the key scope, and the active scope function specifies the entry scope.

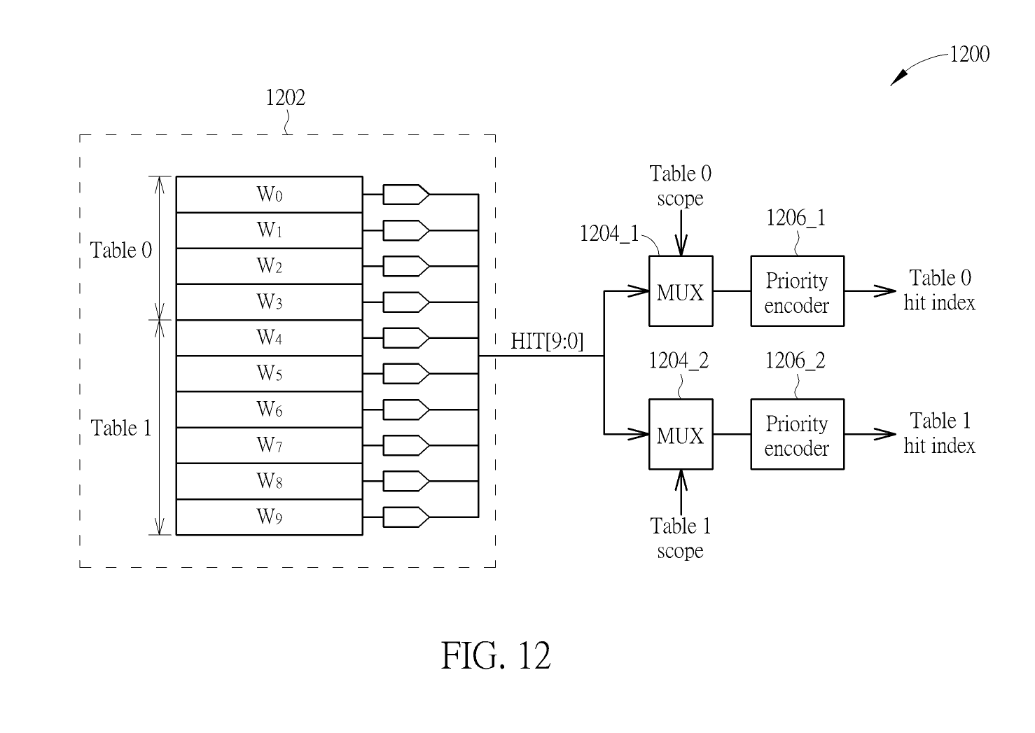

FIG. 12 is a diagram illustrating a CAM based device supporting simultaneous lookup operations for different tables according to an embodiment of the present invention. In this embodiment, the CAM based device is a TCAM 1200, including a TUM 1202, a plurality of multiplexers (MUXs) 1204_1, 1204_2, and a plurality of priority encoders 1206_1, 1206_2. In this embodiment, the TUM 1202 has two tables, including Table 0 and Table 1, stored in TCAM entries W₀-W₃ and TCAM entries W₄-W₉, respectively. The tables are stored in the TUM 1202 in a word-wise aggression fashion, and have identical data words (e.g., identical rules) defined therein. Hence, the same input search key can be compared with different tables in parallel, which avoids the bottleneck of shared TCAM bandwidth. The comparator outputs HIT[9:0] of all TCAM entries W₀-W₉ are transmitted to each of the multiplexers 1204_1 and 1204_2. The multiplexer 1204_1 refers to an entry scope of the first table (i.e., Table 0) to output comparator outputs corresponding to the first table to the priority encoder 1206_1. Similarly, the multiplexer 1204_2 refers to an entry scope of the second table (i.e., Table 1) to output comparator outputs corresponding to the second table to the priority encoder 1206_2. In this way, one search result of searching the first table for the input search key and another search result of searching the second table for the same input search key can be generated in a parallel processing manner.

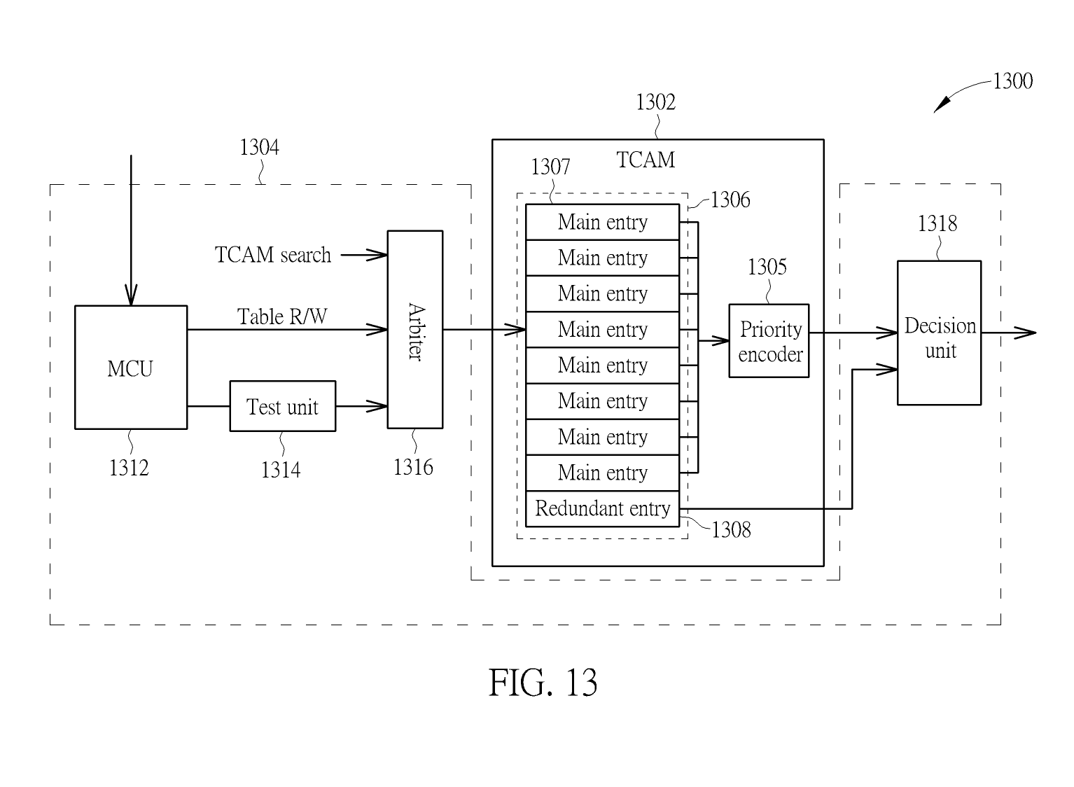

Please refer to FIG. 13, which is a diagram illustrating a table lookup apparatus according to a sixth embodiment of the present invention. In this embodiment, the table lookup apparatus 1300 includes a CAM based device such as TCAM 1302, and further includes a control logic 1304. The TCAM 1302 includes a priority encoder 1305 and a TUM 1306, where the TUM 1306 has a plurality of main TCAM entries 1306 and at least one redundant TCAM entry 1308. For clarity and simplicity, only one redundant TCAM entry 1308 is shown in FIG. 13. However, this is not meant to be a limitation of the present invention. In an alternative design, the TUM 1306 may be configured to have multiple redundant TCAM entries for different purposes.

Normally, the redundant TCAM entry 1308 is not used to store a valid data word for data comparison. However, when the table lookup apparatus 1300 performs a particular task, the redundant TCAM entry 1308 is used to store a valid data word and involved in accomplishing the particular task. For example, the particular task may be a repair task, a table update task, or a runtime test task. When the table lookup apparatus 1300 starts dealing with the particular task, the control logic 1304 is operative to program the redundant CAM entry 1308 by a data word to serve as a new main entry, and utilize the new main entry as replacement of a specific main entry in the CAM based device (e.g., TCAM 1302).

By way of example, but not limitation, the control logic 1304 includes a micro control unit (MCU) 1312, a test unit 1314, an arbiter 1316, and a decision unit 1318. When the table lookup apparatus 1300 performs a normal TCAM search task, the arbiter 1316 allows an input search key to be transmitted to the TCAM 1302. When the table lookup apparatus 1300 performs the particular task, the arbiter 1316 may allow the table read/write operation and/or the test unit 1314 to access the TCAM 1302. Besides, since the redundant TCAM entry 1308 is used to store a valid data word and involved in accomplishing the particular task, the decision unit 1318 is operative to decide a final search result.

The operation of the decision unit 1318 may be represented using the following pseudo codes.

if (REP_HIT==1 && (T_HIT==0 || T_IDX[ ]≧REP_IDX[ ])) {
TCAM_HIT = REP_HIT;
TCAM_IDX[ ] = REP_IDX[ ];
} else {
TCAM_HIT = T_HIT;
TCAM_IDX[ ] = T_IDX[ ];
}

In above pseudo codes, REP_HIT, REP_IDX[ ], T_HIT and T_IDX[ ] are inputs of the decision unit 1318, and TCAM_HIT and TCAM_IDX[ ] are outputs of the decision unit. REP_HIT indicates whether the redundant TCAM entry 1308 has a match condition. REP_IDX[ ] represents an entry index of a main TCAM entry 1307 that is replaced by the redundant TCAM entry 1308. T_HIT indicates whether at least one of the main TCAM entries 1307 has a match condition. T_IDX[ ] represents an entry index of the first matching main TCAM entry. TCAM_HIT indicates whether the TCAM has at least one TCAM entry with a match condition. TCAM_IDX[ ] represents an entry index of the matching TCAM entry.

When REP_HIT indicates that the redundant TCAM entry 1308 has no match condition, TCAM_HIT and TCAM_IDX[ ] are set by T_HIT and T_IDX[ ], respectively.

When REP_HIT indicates that the redundant TCAM entry 1308 has a match condition and T_HIT indicates that none of the main TCAM entries 1307 has a match condition, TCAM_HIT and TCAM_IDX[ ] are set by REP_HIT and REP_IDX[ ], respectively.

When REP_HIT indicates that the redundant TCAM entry 1308 has a match condition and T_HIT indicates that at least one of the main TCAM entries 1307 has a match condition, the entry indices REP_IDX[ ] and T_IDX[ ] are compared. If REP_IDX[ ] is larger than T_IDX[ ], this means the matching main TCAM entry with the entry index T_IDX[ ] has higher priority. Hence, TCAM_HIT and TCAM_IDX[ ] are set by T_HIT and T_IDX[ ], respectively. However, if REP_IDX[ ] is not larger than T_IDX[ ], this means the redundant TCAM entry 1308 associated with the entry index REP_IDX[ ] has higher priority. Hence, TCAM_HIT and TCAM_IDX[ ] are set by REP_HIT and REP_IDX[ ], respectively.

With the help of the decision unit 1318, a failed main TCAM entry with the entry index REP_IDX[ ] can be replaced by the redundant TCAM entry 1308, where a data word to be stored into the failed main TCAM entry will be stored into the redundant TCAM entry 1308. Besides the TCAM entry replacement, the redundant TCAM entry 1308 may be used for table update. In accordance with the conventional table update design, when a new data word is added to a TCAM table, the search operation is stalled for a lot of cycles due to reshuffling the data words in the TCAM. The present invention proposes using the redundant TCAM entry 1308 and the MCU 1312 to prevent the search operation from being stalled.

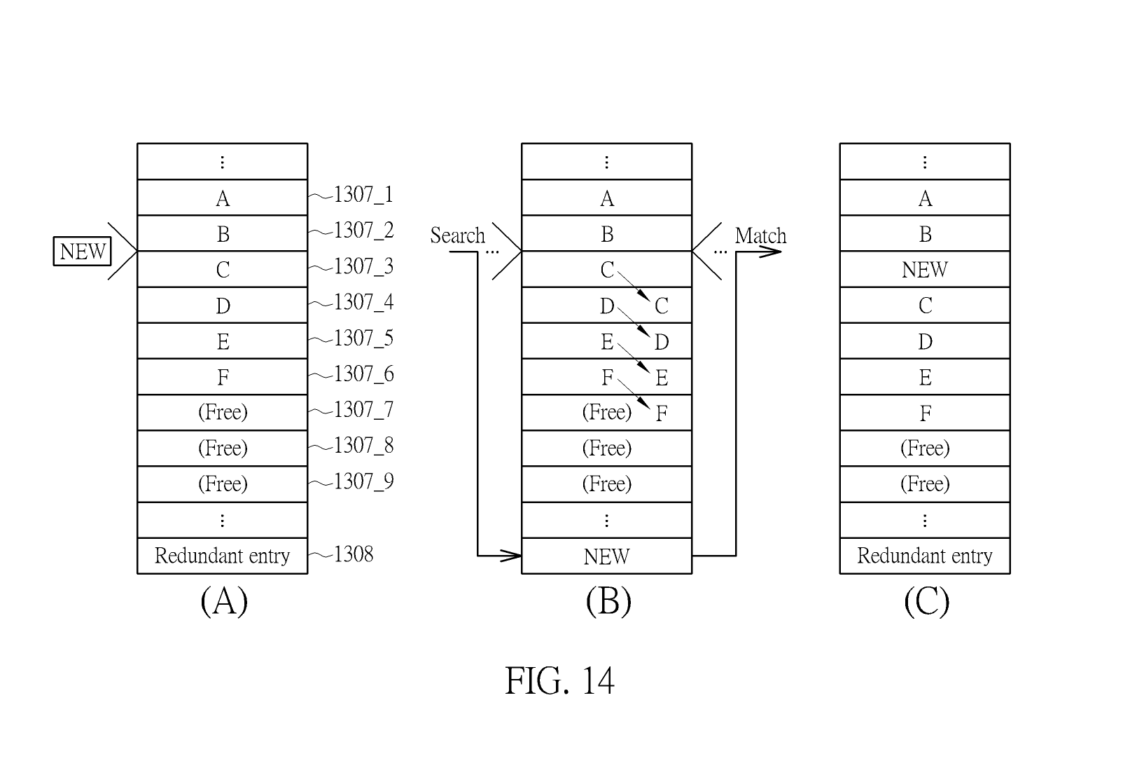

Please refer to FIG. 14, which is a diagram illustrating a table update task performed by the table lookup apparatus 1300 shown in FIG. 13. Suppose that data words A-F of a table are consecutively stored in main TCAM entries 1307_1-1307_6, respectively. The data word F is the last data word of the table, and TCAM entries 1307_7-1307_9 are empty. As shown in sub-diagram (A) of FIG. 14, a new data word NEW is required to be inserted into data words B and C. That is, a rule defined by the new data word NEW would have priority higher than that of a rule defined by the data word C and lower than that of a rule defined by the data word B. The MCU 1312 may be a low-cost processor used to act as an input/output processor (IOP), where the IOP is configured to handle I/O tasks to relieve a host processor (not shown) from frequent I/O tasks. After receiving a table update request from the host processor, the MCU 1312 programs the redundant TCAM entry 1308 to serve as a new main CAM entry that stores the new main CAM entry, as shown in the sub-diagram (B) of FIG. 14. The new main CAM entry (i.e., the redundant CAM entry 1308 with the new data word NEW stored therein) is used to be replacement of the main CAM entry 1307_3, thus allowing data shuffling of the data words C-F to be executed in background without interfering with the normal TCAM search operation. As mentioned above, the decision unit 1318 is operative to decide a final search result. In this case, REP_IDX[ ] is set by the entry index of the main CAM entry 1307_3.

At this moment, the MCU 1312 handles the I/O tasks in background to shuffle data words F-C originally stored in main CAM entries 1307_6-1307_3, starting from the last data word F to the data word C, to next main CAM entries 1307_7-1307_4, as shown in the sub-diagram (B) of FIG. 14. Specifically, the data word F is read from the current main CAM entry 1307_6 and then written into the next main CAM entry 1307_7, the data word E is read from the current main CAM entry 1307_5 and then written into the next main CAM entry 1307_6 to overwrite the data word F, the data word D is read from the current main TCAM entry 1307_4 and then written into the next main CAM entry 1307_5 to overwrite the data word E, and the data word C is read from the current main CAM entry 1307_3 and then written into the next main CAM entry 1307_4 to overwrite the data word D, as shown in the sub-diagram (C) of FIG. 14. After data words C-F are shuffled to the next main CAM entries 1307_4-1307_7, the MCU 1312 programs the main CAM entry 1307_3 by the new data word NEW, and releases the redundant CAM entry 1308 for next use.

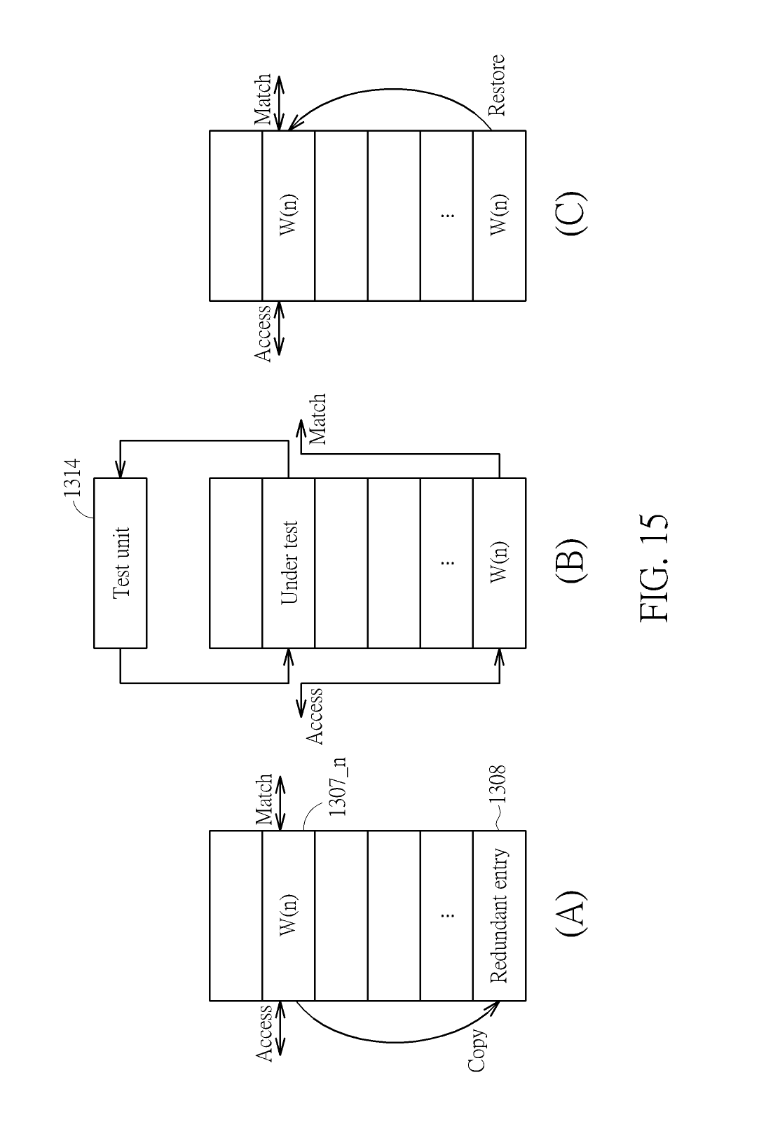

Besides the TCAM entry replacement, the redundant TCAM entry 1308 may be used for runtime test. To detect and recover the failure caused by circuit degradation, one redundant entry may be reserved for testing main entries of the CAM based device one by one. The present invention proposes using the redundant TCAM entry 1308 and the MCU 1312 to perform the test operation in background without blocking the normal access of TCAM 1302. Please refer to FIG. 15, which is a diagram illustrating a runtime test performed by the table lookup apparatus 1300 shown in FIG. 13. Suppose that a data word W(n) of a table is stored in a main TCAM entry 1307_{—}n. As shown in sub-diagram (A) of FIG. 15, the main TCAM entry 1307_{—}n is selected to verify its TCAM cells. As mentioned above, the MCU 1312 may serve as an IOP to handle I/O tasks. Hence, the data word W(n) is copied to the redundant TCAM entry 1308 by the MCU 1312.

After the redundant TCAM entry 1308 is programmed by the data word W(n), the test unit 1314 starts verifying TCAM cells of the TCAM entry 1307_{—}n. The test unit 1314 may write a predetermined data pattern into the TCAM entry 1307_{—}n, and then check the discharging and leaking characteristics of TCAM cells to verify functionality of the TCAM entry 1307_{—}n, as shown in sub-diagram (B) of FIG. 15. The new main CAM entry (i.e., the redundant CAM entry 1308 with the data word W(n) stored therein) is used to be replacement of the main CAM entry 1307_{—}n, thus allowing the test operation of the main TCAM entry 1307_{—}n to be executed in background without interfering with the normal TCAM search operation. As mentioned above, the decision unit 1318 is operative to decide a final search result. In this case, REP_IDX[ ] is set by the entry index of the main CAM entry 1307_{—}n. To prevent the normal TCAM access from being affected by the runtime test, the test requests have the lowest priority, and only one bit (i.e., only one TCAM cell) is tested for each test request used to verify the discharging characteristic. Besides, the minimum time interval between two test requests is constrained.

After the runtime test of the main TCAM entry 1307_{—}n is accomplished, the MCU 1314 restores the data word W(n) in the redundant TCAM entry 1308 to the main TCAM entry 1307_{—}n, and releases the redundant TCAM entry 1308 for next use, as shown in sub-diagram (C) of FIG. 15. Please note that the copying and restoring operations may also refresh the TCAM contents, which is helpful if the content retention problem occurs.

The aforementioned table lookup apparatus may be employed by a network device such as a network switch. However, this is not meant to be a limitation of the present invention. Any application requiring a table lookup function may use the proposed table lookup apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A table lookup apparatus, comprising:
a content-addressable memory (CAM) based device, configured to store at least one table; and
a first cache, configured to cache at least one input search key of the CAM based device and at least one corresponding search result.

2. The table lookup apparatus of claim 1, further comprising:
a plurality of second caches, each configured to cache at least one input search key of the CAM based device and at least one corresponding search result; and
an arbiter, coupled between the first cache and each of the second caches, the arbiter configured to arbitrate access of the first cache between the second caches.

3. The table lookup apparatus of claim 1, wherein the first cache is a non-blocking cache.

4. The table lookup apparatus of claim 1, wherein the first cache supports an out-of-order completion.

5. The table lookup apparatus of claim 1, wherein the first cache invalidates cached data when a table content in the CAM based device is changed.

6. A table lookup apparatus, comprising:
a content-addressable memory (CAM) based device, having CAM entries configured to vertically store a plurality of tables in a word-wise aggression fashion, wherein the CAM entries are responsive to a valid bit input including valid bits of the CAM entries, and a CAM entry is invalid when receiving a corresponding valid bit set by a predetermined logic value; and
a scope mask circuit, configured to mask a portion of the valid bit input by assigning the predetermined logic value to each valid bit included in the portion of the valid bit input, wherein the portion of the valid bit input corresponds to non-selected table (s).

7. The table lookup apparatus of claim 6, wherein the scope mask circuit comprises:
a scope mapper, configured to receive a table index of a selected table, and generate an entry index of a beginning CAM entry of the selected table and an entry index of an ending CAM entry of the selected table; and
a scope decoder, configured to set the valid bit input according to the entry index of the beginning CAM entry of the selected table and the entry index of the ending CAM entry of the selected table.

8. A table lookup apparatus, comprising:
a content-addressable memory (CAM) based device, having a plurality of main CAM entries and at least a redundant CAM entry; and
a control logic, configured to program the redundant CAM entry by a data word to serve as a new main CAM entry, utilize the new main entry as replacement of a specific main CAM entry in the CAM based device, and program the specific main CAM entry by the data word.

9. The table lookup apparatus of claim 8, wherein the data word programmed into the redundant CAM entry is a new data word to be added to the CAM based device.

10. The table lookup apparatus of claim 9, wherein while utilizing the new main CAM entry as replacement of the specific main CAM entry, the control logic is further configured to shuffle data words originally stored in main CAM entries, starting from a last data word of a table to a specific data word of the table that is stored in the specific main CAM entry, to next main CAM entries in background.

11. The table lookup apparatus of claim 10, wherein the control logic programs the specific main CAM entry by the new data word and releases the redundant CAM entry after the data words are shuffled to the next main CAM entries.

12. The table lookup apparatus of claim 8, wherein the data word programmed into the redundant CAM entry is a data word originally stored in the specific main CAM entry in the CAM based device.

13. The table lookup apparatus of claim 12, further comprising:
a test unit, configured to perform a runtime test upon the specific main CAM entry while the new main CAM entry is utilized as replacement of the specific main CAM entry.

14. The table lookup apparatus of claim 13, wherein the control logic restores the data word in the redundant CAM entry to the specific main CAM entry after the runtime test performed upon the specific main CAM entry is accomplished.

15. A table lookup method, comprising:
storing at least one table in a content-addressable memory (CAM) based device; and
caching at least one input search key of the CAM based device and at least one corresponding search result.

16. A table lookup method, comprising:
vertically storing a plurality of tables in content-addressable memory (CAM) entries of a CAM based device in a word-wise aggression fashion, wherein the CAM entries are responsive to a valid bit input including valid bits of the CAM entries, and a CAM entry is valid when receiving a corresponding valid bit set by a first logic value and is invalid when receiving the corresponding valid bit set by a second logic value; and
masking a portion of the valid bit input by assigning the second logic value to each valid bit included in the portion of the valid bit input, wherein the portion of the valid bit input corresponds to non-selected table(s).

17. A table lookup method, comprising:
utilizing a content-addressable memory (CAM) based device having a plurality of main CAM entries and at least a redundant CAM entry;
programming the redundant CAM entry by a data word to serve as a new main CAM entry;
utilizing the new main CAM entry as replacement of a specific main CAM entry in the CAM based device; and
programming the specific main CAM entry by the data word.
